(19) United States
(12) Patent Application Publication
(10) Pub. No.: US 2024/0427580 A1
(43) Pub. Date: Dec. 26, 2024

(54) PROGRAMMING LANGUAGE CONVERSION DEVICE, PROGRAMMING LANGUAGE CONVERSION METHOD, AND PROGRAMMING LANGUAGE CONVERSION SYSTEM

(71) Applicant: Hitachi, Ltd., Tokyo (JP)

(72) Inventors: Jinan DAI, Tokyo (JP); Shinji ITOH, Tokyo (JP); Shuhei NOJIRI, Tokyo (JP); Yuichi SAIDA, Tokyo (JP); Kunihiko IWAKI, Tokyo (JP)

(21) Appl. No.: 18/669,850

(22) Filed: May 21, 2024

(30) Foreign Application Priority Data
Jun. 22, 2023 (JP) 2023-102577

(51) Int. Cl. G06F 8/51

(52) U.S. Cl. CPC G06F 8/51

(57) ABSTRACT

Provided is a programming language conversion device capable of converting source code written in a programming language before migration used in a legacy system into source code written in a programming language after migration. A programming language conversion device 100 includes a data masking unit 220 that masks a specific type of token of first source code written in a first programming language with a different placeholder for each of the tokens, and a preliminary learning unit 250 and a main learning unit 260 that learn the first source code masked with the placeholder and create a translation model for converting the first source code into second source code written in a second programming language.

### CROSS-REFERENCE TO RELATED APPLICATION

The present application claims priority from Japanese application JP2023-102577, filed on Jun. 22, 2023, the content of which is hereby incorporated by reference into this application.

### TECHNICAL FIELD

The present invention relates to a programming language conversion device, a programming language conversion method, and a programming language conversion system.

### BACKGROUND ART

In recent years, machine translation from a programming language (for example, the COBOL language) before migration with a small amount of source code to a new language (for example, the Java (registered trademark) language) with a large amount of source code has been studied. However, machine translation using a conventional rule base requires a large amount of cost to implement and update a rule and a tool. For this reason, processing of programming language conversion based on deep learning using artificial intelligence (AI) has been studied. The processing of programming language conversion is, for example, processing of converting existing source code created in a programming language before migration into source code created in a programming language after migration.

Deep learning is mainly performed in three phases of “data set preprocessing”, “preliminary learning”, and “main learning”.

The data set preprocessing is processing for converting source code written in two types of programming languages for learning into a form that can be input into a deep learning model.

The preliminary learning is processing for causing a deep learning model to learn features (for example, syntax, grammar, and the like) of each of two types of programming languages.

The main learning is processing of learning that allows a deep learning model to convert source code of an old programming language into source code of a new programming language. By the main learning, source code of an old programming language is associated with source code of a new programming language.

Here, conventional data set preprocessing will be described.

In conventional data set preprocessing, a conventional programming language conversion device extracts source code written in a programming language before migration from a folder of various software projects. After performing selection processing of removing the partially missing source code and initial processing based on the extracted source code, the source code is put together into one data set file. For example, each file of source code is put together in one line in a data set file.

Next, a conventional programming language conversion device converts a data set file into a data set according to each use of preliminary learning and main learning. A preliminary learning data set is a data set put together in one line for each file of source code, and has the same format as the data set file created by the data set preprocessing described above. On the other hand, a main learning data set is a data set put together in one line for each function (for example, method or function) of source code. For this reason, data of one line in a preliminary learning data set becomes data of a plurality of lines in a main learning data set. In the preliminary learning data set and the main learning data set, although forms of collected data set files are changed, content of data is the same.

Next, the conventional programming language conversion device converts each of the preliminary learning data set and the main learning data set into a binary file that can be input to a deep learning model through a standard processing process (tokenization or the like) of natural language processing.

In the preliminary learning, the conventional programming language conversion device creates a language model learned by associating a preliminary learning data set created from source code written in a programming language before migration with a preliminary learning data set created from source code written in a programming language after migration. The language model is basic knowledge such as grammar and syntax related to a programming language in which source code is written, and is also referred to as a translation model in description below.

In the main learning, the conventional programming language conversion device uses a main learning data set created from source code written in a programming language before migration and a main learning data set created from source code written in a programming language after migration as input, and constructs and learns a translation model by adding a translation layer to the learned language model.

PTL 1 discloses a technique related to unsupervised translation of a programming language.

### CITATION LIST

### Patent Literature

PTL 1: Marie-Anne Lachaux, and three others [online]

Unsupervised Machine Translation of Programming Language, [searched on Jun. 1, 2023] Internet (URL:

https://arxiv.org/abs/2006.03511)

### SUMMARY OF INVENTION

### Technical Problem

Machine translation based on deep learning basically requires a parallel data set, that is, a data set with a parallel translation. Further, in order to create a deep learning model, a large amount of data is required in a process of each piece of the processing described above.

However, source code written in a programming language before migration, such as the COBOL language used in a legacy system is not generally available in public, and the number of pieces of source code is also smaller than that of a sample of a natural language. For this reason, unlike translation of a natural language, there is often no parallel data set in conversion of a programming language, and thus unsupervised learning is required. However, since there is little data available for learning, it has been difficult to improve quality of a deep learning model created by unsupervised learning.

Further, in a case where the conventional programming language conversion processing is applied as it is, a problem below has occurred.

A first problem is that a character string and a constant written in source code overloads a dictionary and become noise of learning. The dictionary is a set of all tokens included in preprocessed source code. Size of a dictionary for learning is limited. When a dictionary is constructed through preprocessing similar to natural language processing, the dictionary is overloaded by a token that does not affect logic of a program. For example, many character strings and constants do not affect logic of a program, and many source codes created in Japan are written in Japanese. Even words having the same meaning often appear as different words from a deep learning model, and thus a dictionary expands more than necessary.

Further, in a deep learning model, it is necessary to assign only one vector to each token to perform learning, and in a process of learning, a tensor is assigned to all tokens. Since a token (for example, a comment written in source code, or the like) having a low appearance frequency also becomes noise in a learning process, learning quality of a vector itself is lowered. For example, in source code written in a programming language before migration, an annotation or the like is written in Japanese, or a special constant is defined. In a case where such annotations and constants are included in a dictionary used in data set preprocessing, the dictionary is overloaded, and noise is likely to occur in preliminary learning and main learning. Then, since a deep learning model is a black box, there is a possibility that noise adversely affects the entire model.

The second problem is that, in a case of unsupervised learning, when topics (functions) of both languages of learning data are different, translation quality of a translation model is significantly affected. For example, in a case where a program before migration is created on the assumption of batch processing executed locally, and a program after migration is created on the assumption of DB access processing executed on the Web, topics of the programs are different. In a translation model learned by associating a program before migration and a program after migration having different topics, quality of translation is lowered.

The present invention has been made in view of such a situation, and an object of the present invention is to improve quality of a translation model for converting source code written in a first programming language into a second programming language.

### Solution to Problem

A programming language conversion device according to the present invention includes a masking unit that masks a specific type of token of first source code written in a first programming language with a different placeholder for each of the tokens, and a learning unit that learns the first source code masked with the placeholder and creates a translation model for converting the first source code into second source code written in a second programming language.

Advantageous Effects of Invention

According to the present invention, since quality of a translation model is improved, translation in which source code written in a first programming language is converted into source code written in a second programming language is correctly performed.

An object, a configuration, and an advantageous effect other than those described above will be clarified in description of an embodiment described below.

### BRIEF DESCRIPTION OF DRAWINGS

FIG. 1 is a block diagram illustrating a hardware configuration example of a programming language conversion device according to a first embodiment of the present invention.

FIG. 2 is a block diagram illustrating a functional configuration example of the programming language conversion device according to the first embodiment of the present invention.

FIG. 3 is a diagram illustrating content of a source file group according to the first embodiment of the present invention.

FIG. 4 is a diagram illustrating content of a mask source file group according to the first embodiment of the present invention.

FIG. 5 is a diagram illustrating content of a placeholder mapping group according to the first embodiment of the present invention.

FIG. 6 is a diagram illustrating content of a preliminary learning data group according to the first embodiment of the present invention.

FIG. 7 is a diagram illustrating content of a main learning data group according to the first embodiment of the present invention.

FIG. 8 is a flowchart showing processing of a learning process of the programming language conversion device according to the first embodiment of the present invention.

FIG. 9 is a flowchart showing an example of detailed processing of data masking processing according to the first embodiment of the present invention.

FIG. 10 is a diagram illustrating an example of an AST according to the first embodiment of the present invention.

FIG. 11 is a flowchart showing an example of preliminary learning data processing according to the first embodiment of the present invention.

FIG. 12 is a diagram illustrating an example of a dictionary according to the first embodiment of the present invention.

FIG. 13 is a flowchart showing an example of main learning data processing according to the first embodiment of the present invention.

FIG. 14 is a flowchart showing an example of processing of a translation process of the programming language conversion device according to the first embodiment of the present invention.

FIG. 15 is a block diagram illustrating a configuration example of a programming language conversion system according to a second embodiment of the present invention.

### DESCRIPTION OF EMBODIMENTS

Hereinafter, an embodiment of the present invention will be described with reference to the accompanying drawings. In the present description and the drawings, constituent elements having substantially the same function or configuration are denoted by the same reference signs, and redundant description is omitted.

### First Embodiment

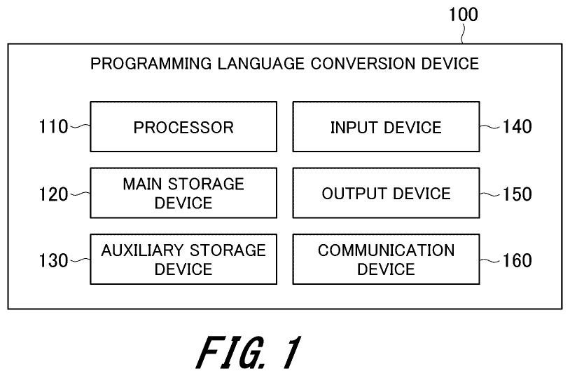

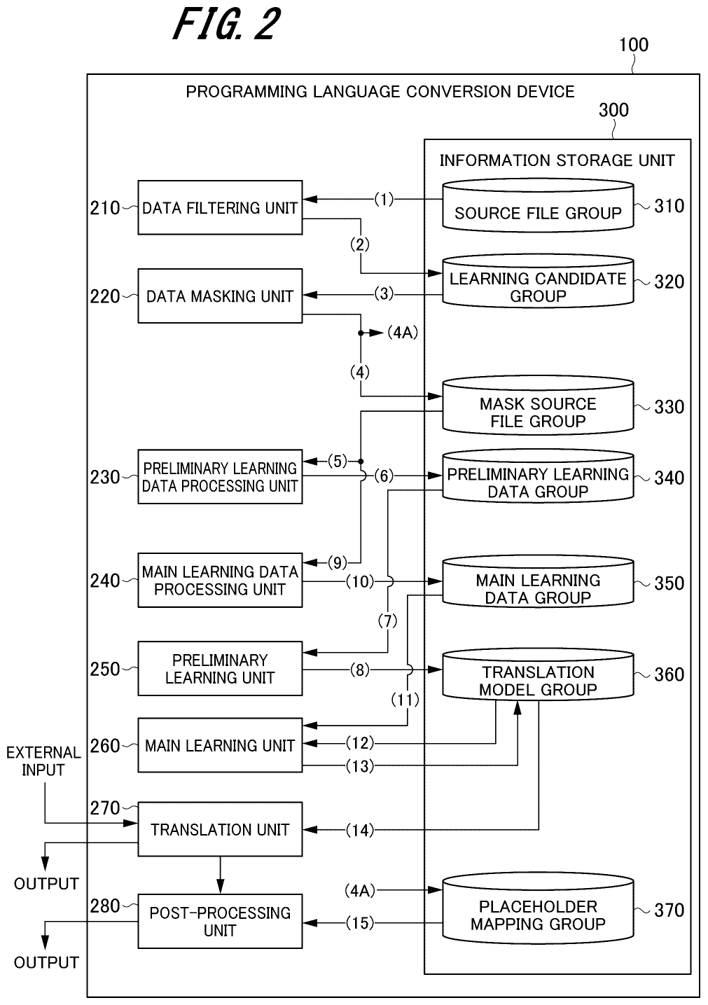

FIG. 1 is a block diagram illustrating a hardware configuration example of a programming language conversion device 100 according to a first embodiment. The programming language conversion device 100 is an example of a computer capable of realizing conversion processing of a programming language according to the present embodiment. The programming language conversion device 100 according to the present embodiment executes conversion processing of a programming language according to the present embodiment, so as to realize a programming language conversion method performed by functional blocks illustrated in FIG. 2 to be described later in cooperation.

The programming language conversion device 100 includes a processor 110, a main storage device 120, an auxiliary storage device 130, an input device 140, an output device 150, and a communication device 160.

The processor 110 reads, from the main storage device 120, program code of software for realizing each function according to the present embodiment, and executes the program code. For example, a read only memory (ROM), a random access memory (RAM), or the like is used as the main storage device 120. A variable, a parameter, and the like generated during arithmetic processing of the processor 110 are temporarily written to the main storage device 120, and these variable, parameter, and the like are appropriately read by the processor 110. However, a central processing unit (CPU), a micro processing unit (MPU), a graphics processing unit (GPU), or the like is used as the processor 110.

As the input device 140, for example, a keyboard, a mouse, or the like is used, and the user can perform predetermined operation input and instruction. The output device 150 is, for example, a liquid crystal display monitor, and displays a result of processing performed by the programming language conversion device 100 and the like to the user.

As the auxiliary storage device 130, for example, a hard disk drive (HDD), a solid state drive (SSD), a magneto-optical disk, a non-volatile memory, or the like is used. In the auxiliary storage device 130, a program for causing the programming language conversion device 100 to function is recorded in addition to an operating system (OS) and various parameters. The auxiliary storage device 130 records a program, data, and the like necessary for the processor 110 to operate, and is used as an example of a non-transitory computer-readable storage medium storing a program to be executed by the programming language conversion device 100.

For example, a network interface card (NIC) or the like is used for the communication device 160, and various pieces of data can be transmitted and received between devices via a local area network (LAN), a dedicated line, or the like connected to a terminal of the NIC.

Next, a functional configuration example of the programming language conversion device 100 and each database will be described with reference to FIGS. 2 to 7. FIG. 2 is a block diagram illustrating a functional configuration example of the programming language conversion device 100. In description below, each piece of processing will be described together with numbers indicating processing order illustrated in FIG. 2.

The programming language conversion device 100 includes a data filtering unit 210, a data masking unit 220, a preliminary learning data processing unit 230, a main learning data processing unit 240, a preliminary learning unit 250, a main learning unit 260, a translation unit 270, a post-processing unit 280, and an information storage unit 300. The information storage unit 300 includes a source file group 310, a learning candidate group 320, a mask source file group 330, a preliminary learning data group 340, a main learning data group 350, a translation model group 360, and a placeholder mapping group 370.

### (1) Reading of Source File

First, the data filtering unit 210 filters first source code based on a topic. For example, the data filtering unit 210 reads a source file written by a program before migration and a source file written by a program after migration from the source file group 310 of the information storage unit 300, and filters source code written in the source file. For this reason, the data filtering unit 210 uses one type or a plurality of types of filtering methods for a data set of a programming language after migration, and utilizes a characteristic of a programming language to classify source code for each topic based on a part or all of the source code. After the above, the data filtering unit 210 filters out source code of a topic (application) with a clear difference.

Here, an example of a filtering method used in the data filtering unit 210 will be described. (a) Filtering method based on keyword

For example, for source code written in the Java language, the data filtering unit 210 performs filtering based on a keyword of a package name of an imported library, and filters out a source code having a partially different application. For example, if com. android is written in source code, it is source code for a mobile application, and if HttpServlet is written, it is source code of a Web application, and thus, both are targets of filtering out. As described above, when filtering source code, the data filtering unit 210 can determine to exclude information such as import, comment, annotation, and the like written in the source code by optionally combining these pieces of information.

### (b) Classification Method Based on Topic

The data filtering unit 210 uses a feature of a programming language to divide a variable name, identify source code for each word, and then performs filtering by a topic classification method. In filtering by the topic classification method, static analysis of source code is performed, and tokenization (division) is performed on entire source code. For example, when a character string written in source code is “CamelCase”, the character string is divided into two words “camel” and “case”. Further, in a case where a character string is two words “snake case” connected by an underscore, the underscore is removed and the character string is divided into two words “snake” and “case”.

Since a programming language has a strict structure, the data filtering unit 210 can extract only partial information from source code by a classification method based on a topic, and can greatly improve classification efficiency with a small accuracy loss. Further, the data filtering unit 210 can exclude a specific type of token (for example, a comment and an annotation (note)) such as a character string written in source code from input to a topic classification method by performing abstract syntax tree (AST) analysis. Furthermore, the data filtering unit 210 can also perform topic classification of a comment and an annotation (note) by extracting only one of the comment and the annotation (note) and inputting the extracted one to a topic classification method.

Note that, as a topic classification method, a method in which clustering by a statistical method such as linear discriminant analysis (LDA) is performed on entire text or a part of source code, and an obviously different topic is detected by a word having a high weight of each cluster may be used. In a case where the above-described AST analysis and LDA are used in combination, execution time of LDA can be greatly reduced by performing LDA after removing unnecessary data by AST analysis in advance. Further, as a topic classification method, a method based on deep learning (for example, a neural network) may be used.

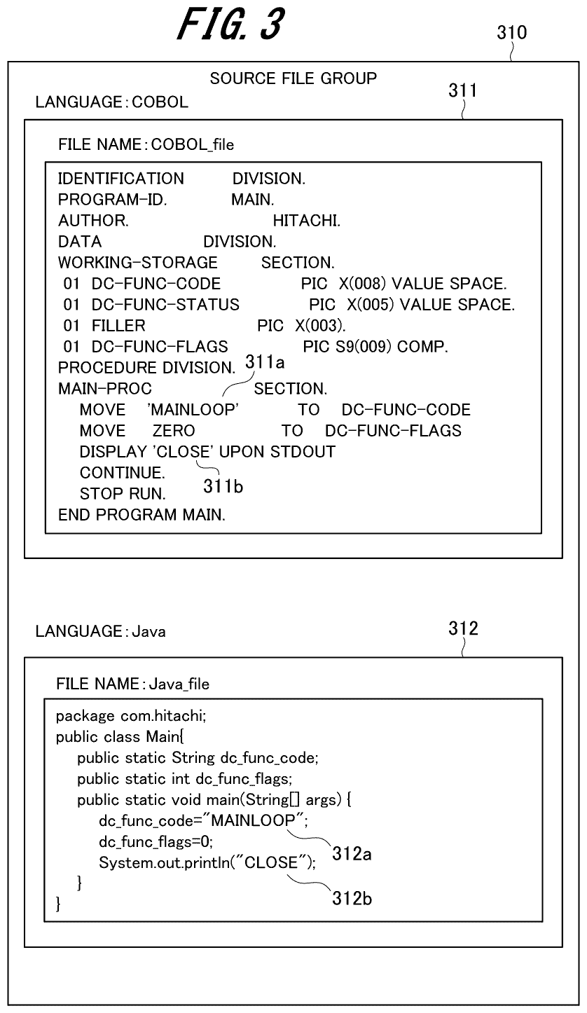

FIG. 3 is a diagram illustrating content of the source file group 310.

The source file group 310 includes a source file 311 written in the COBOL language (an example of a first programming language) as a program before migration and a source file 312 written in the Java language as a program after migration. A function of processing performed by the source file 311 is the same as a function of processing performed by the source file 312. In the source files 311 and 312, tokens 311a, 311b, 312a, and 312b as a target of masking by data masking processing to be described later are illustrated. A token is a character string, a constant, or the like written in source code, and is to be replaced with a placeholder. A token is identified by division at a word level using a division algorithm for natural language processing or by division at a subword level using a statistical method after that.

### (2) Writing of Learning Candidate Group

The description returns to FIG. 2.

The data filtering unit 210 performs filtering processing based on the source file 311 written in a program before migration and the source file 312 written in a program after migration read from the source file group 310. By the filtering processing, an unnecessary source file is excluded in both the preliminary learning and the main learning. After the above, the data filtering unit 210 writes data that can be used as learning data as a learning candidate in the learning candidate group 320 of the information storage unit 300. The learning candidate group 320 is a set of a plurality of source files.

### (3) Reading of Learning Candidate Group

Next, the data masking unit 220 masks a filtered first source code with a different placeholder for each token. For example, the data masking unit 220 reads a learning candidate from the information storage unit 300 and performs data masking processing of masking a predetermined portion in each source file.

### (4) Masking Processing

Next, the data masking unit 220 masks a specific type of token of the first source code of the source file 311 written in the COBOL language with a different placeholder for each token. For this reason, the data masking unit 220 creates a data set in which a source file subjected to data masking processing by replacing a constant and a character string in source code of a program before migration and a program after migration with a placeholder is set as a mask source file using a parser for analyzing a program. After the above, the data masking unit 220 writes a mask source file into the mask source file group 330 of the information storage unit 300.

### (4A) Writing of Map

In addition, the data masking unit 220 writes a map representing correspondence between a placeholder, a constant, and a character string in the placeholder mapping group 370 of the information storage unit 300. In the placeholder mapping group 370, an original character string masked in a source file and a placeholder masking the original character string are recorded in association with each other.

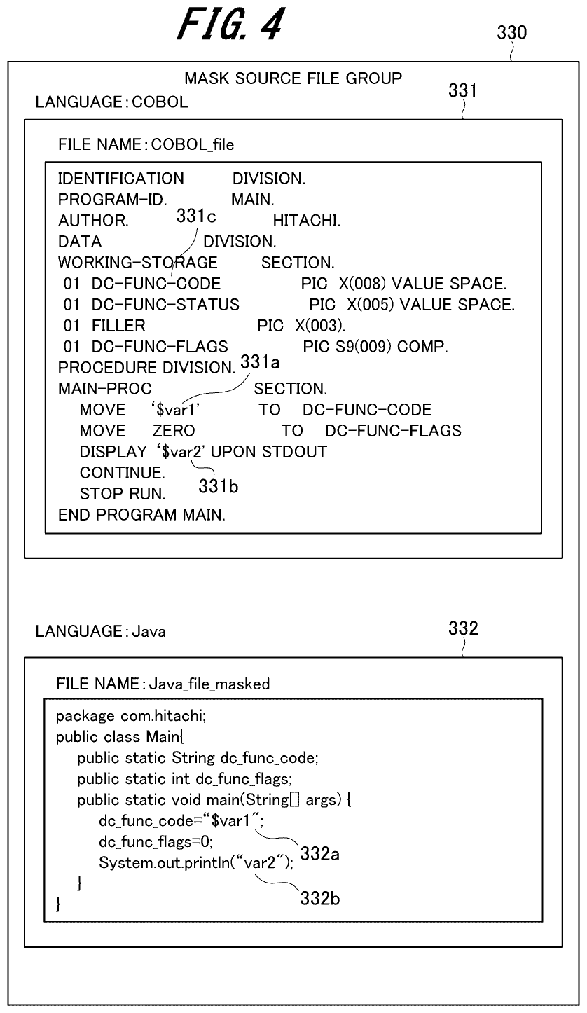

FIG. 4 is a diagram illustrating content of the mask source file group 330.

The mask source file group 330 includes a mask source file 331 in which a part of the source file 311 written by a program before migration is masked and a mask source file 332 in which a part of the source file 312 written by a program after migration is masked. The tokens 311a, 311b, 312a, and 312b illustrated in FIG. 3 are masked by mask information 331a, 331b, 332a, and 332b, respectively.

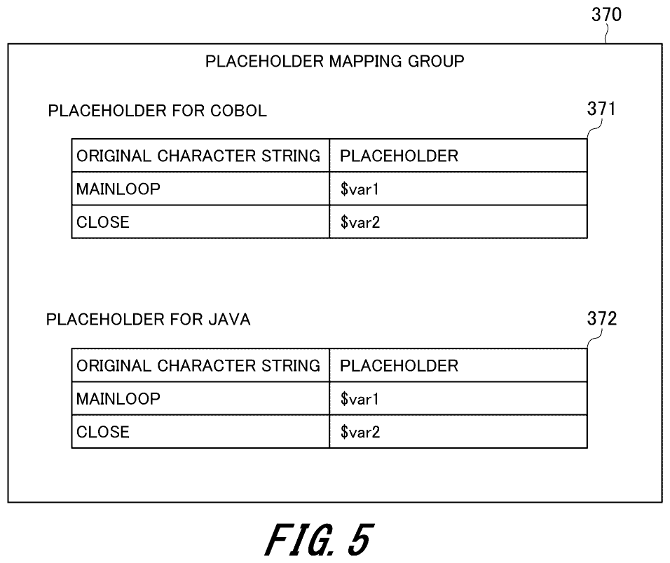

FIG. 5 is a diagram illustrating content of the placeholder mapping group 370.

As described above, mask information is also written to the placeholder mapping group 370. A placeholder is another character string with which a character string written in an original source file is replaced. Placeholder mapping 371 shows that an original character string “MAINLOOP” of the source file 311 written in the COBOL language is masked by a placeholder “$var1” and an original character string “CLOSE” is masked by a placeholder “$var2”. Further, placeholder mapping 372 shows that an original character string “MAINLOOP” of the source file 312 written in the Java language is masked by a placeholder “$var1” and an original character string “CLOSE” is masked by a placeholder “$var2”. As described above, the mask information 331a, 331b, 332a, and 332b illustrated in FIG. 4 is read as a placeholder.

### (5), (6) Processing for Preliminary Learning Data

The description returns to FIG. 2. The preliminary learning data processing unit 230 performs processing of converting the first source code masked with a placeholder into preliminary learning data. For example, the preliminary learning data processing unit 230 reads the mask source files 331 and 332 from the mask source file group 330, and performs preliminary learning data processing. After the above, the preliminary learning data processing unit 230 writes preliminary learning data files 341 and 342 obtained by performing the preliminary learning data processing on the mask source files 331 and 332 into the preliminary learning data group 340 of the information storage unit 300.

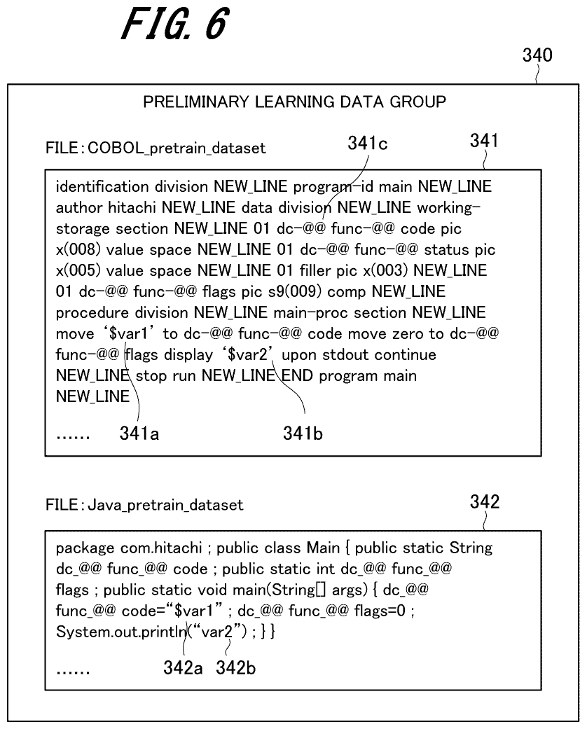

FIG. 6 is a diagram illustrating content of the preliminary learning data group 340.

The preliminary learning data group 340 includes the preliminary learning data files 341 and 342 that are a result of performing the preliminary learning data processing on the mask source files 331 and 332. A file name of the preliminary learning data file 341 is given

“COBOL_pretrain_dataset”, and a file name of the preliminary learning data 342 is given “Java pretrain_dataset”.

The preliminary learning data file 341 is obtained by putting together source code written in the mask source file 331 illustrated in FIG. 4 into one line. Note that, in the diagram, the source code is wrapped at the right end and displayed. “NEW LINE” is added to a line break point of the preliminary learning data file 341. Further, a semicolon is added to a line break point of the preliminary learning data 342. The preliminary learning data files 341 and 342 include placeholders 341a, 341b, 342a, and 342b corresponding to placeholders attached to the mask source files 331 and 332.

The description returns to FIG. 2.

### (7), (8) Preliminary Learning Processing

The preliminary learning unit 250 learns the first source code masked with a placeholder, and creates translation model for converting the first source code into second source code written in the Java language (an example of a second programming language). The translation model is an example of a deep learning model created in the present embodiment.

The preliminary learning unit 250 reads the preliminary learning data files 341 and 342 from the preliminary learning data group 340 and performs preliminary learning. The preliminary learning is processing of learning a feature (syntax, grammar, and the like) of a programming language before migration and a programming language after migration as described above, and creates a translation model in which features of the COBOL language and the Java language are learned based on preliminary learning data. After the above, the preliminary learning unit 250 writes a result of the preliminary learning in the translation model group 360 of the information storage unit 300 as a translation model. The translation model is, for example, one binary file.

(9), (10) Processing for Main Learning Data

Next, the main learning data processing unit 240 performs processing of converting the first source code masked with a placeholder into main learning data. For example, the main learning data processing unit 240 reads the mask source files 331 and 332 from the mask source file group 330 and performs main learning data processing. After the above, the main learning data processing unit 240 writes main learning data files 351 and 352 obtained by performing main learning data processing on the mask source files 331 and 332 into the main learning data group 350 of the information storage unit 300.

Note that (9) processing of reading a mask source file in processing for main learning data and (5) processing of reading a mask source file in processing for preliminary learning data described above may be performed simultaneously, or the order may be changed.

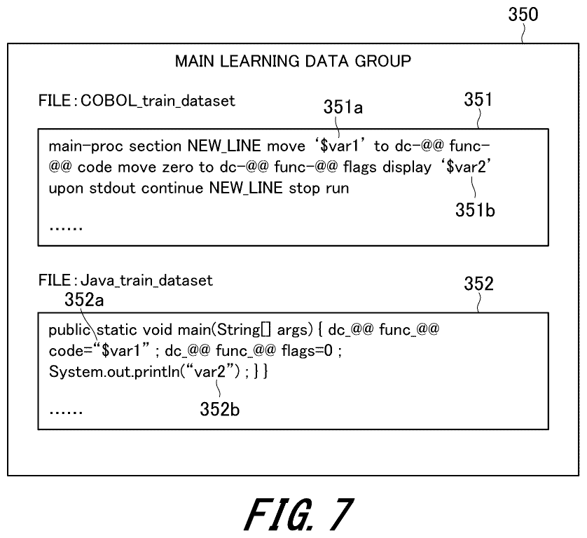

FIG. 7 is a diagram illustrating content of the main learning data group 350.

The main learning data group 350 includes the main learning data files 351 and 352 that are a result of performing main learning data processing on the mask source files 331 and 332. A file name of the main learning data file 351 is given “COBOL_train_dataset”, and a file name of the main learning data 352 is given “Java_train dataset”.

The main learning data file 351 is obtained by deleting unnecessary information from the mask source file 331 for main learning. The main learning data files 351 and 352 include placeholders 351a, 351b, 352a, and 352b corresponding to placeholders attached to the mask source files 331 and 332.

The description returns to FIG. 2.

### (11), (12), (13) Main Learning Processing

Next, the main learning unit 260 creates a translation model based on main learning data. For example, the main learning unit 260 reads the main learning data files 351 and 352 from the main learning data group 350, reads a translation model obtained by preliminary learning from the translation model group 360, and performs main learning. The main learning is processing of creating a translation model for converting source code written in a programming language before migration into source code written in a programming language after migration. After the above, the main learning unit 260 writes a result of the main learning in the translation model group 360 of the information storage unit 300 as a translation model.

### (14) Translation Processing

Next, the translation unit 270 applies a translation model to the first source code to convert the first source code into second source code. For example, the translation unit 270 obtains a translation result obtained by applying data input from the outside to a translation model read from the translation model group 360. Data input from the outside is, for example, source code written in a programming language before migration. However, data input from the outside needs to be in a state where a translation model can be applied. In view of the above, main learning data processing by the main learning data processing unit 240 is performed on data input from the outside. A translation model is applied to data on which main learning data processing is performed.

A translation result obtained from the translation unit 270 is in a state in which a character string is replaced with a placeholder. In a case where there is no user's instruction for post-processing and there is demand for obtaining a translation result also in this state, the translation unit 270 outputs the second source code in which a specific token is masked with a placeholder. That is, the translation unit 270 outputs a translation result in a state where a character string is replaced with a placeholder. An output translation result is displayed or printed by the output device 150 illustrated in FIG. 1.

### (15) Post-Processing

In a case where there is an instruction of post-processing by the user, the post-processing unit 280 performs post-processing of returning a placeholder to an original state, and outputs the second source code on which the post-processing is performed. For example, the post-processing unit 280 replaces a placeholder of source code translated by the translation unit 270 with an original character string acquired with reference to the placeholder mapping group 370, and automatically restores the source code. A translation result after post-processing is displayed or printed by the output device 150 illustrated in FIG. 1.

### Detailed content of Each Piece of Processing

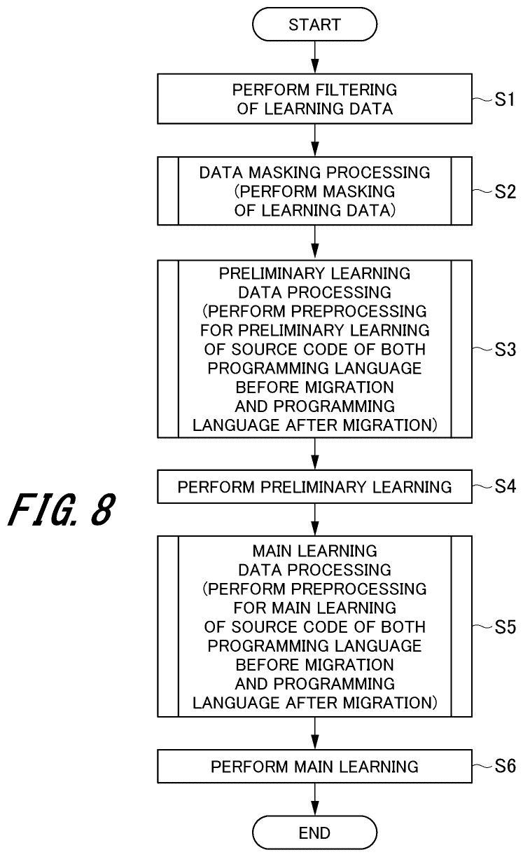

Next, detailed content of a programming language conversion method performed by each functional unit of the programming language conversion device 100 will be described with reference to FIGS. 8 to 13. Note that, in description below, there is a case where processing of writing various pieces of data in the information storage unit 300 is omitted.

FIG. 8 is a flowchart showing processing in a learning process of the programming language conversion device 100. Here, processing up to main learning will be described.

First, the data filtering unit 210 performs filtering of the source files 311 and 312 read as learning data from the source file group 310 (S1). The filtered source files 311 and 312 are stored in the learning candidate group 320.

Next, the data masking unit 220 performs data masking processing (S2). In the data masking processing, the data masking unit 220 performs masking on the source files 311 and 312 read from the learning candidate group 320 as learning data.

Next, the preliminary learning data processing unit 230 performs preliminary learning data processing (S3). In the preliminary learning data processing, the preliminary learning data processing unit 230 performs preprocessing for preliminary learning on both source code written in a programming language before migration and source code written in a programming language after migration. A result of performing the preliminary learning data processing is stored in the preliminary learning data group 340.

Next, the preliminary learning unit 250 performs preliminary learning based on the preliminary learning data files 341 and 342 read from the preliminary learning data group 340 (S4).

Next, the main learning data processing unit 240 performs main learning data processing (S5). In the main learning data processing, the main learning data processing unit 240 performs preprocessing for main learning on both source code written in a programming language before migration and source code written in a programming language after migration. A result of performing the main learning data processing is stored in the main learning data group 350.

Finally, the main learning unit 260 performs main learning by using the main learning data files 351 and 352 read from the main learning data group 350 and the translation model read from the translation model group 360 (S6), and ends the main processing. After the main learning is performed, the translation model is stored in the translation model group 360.

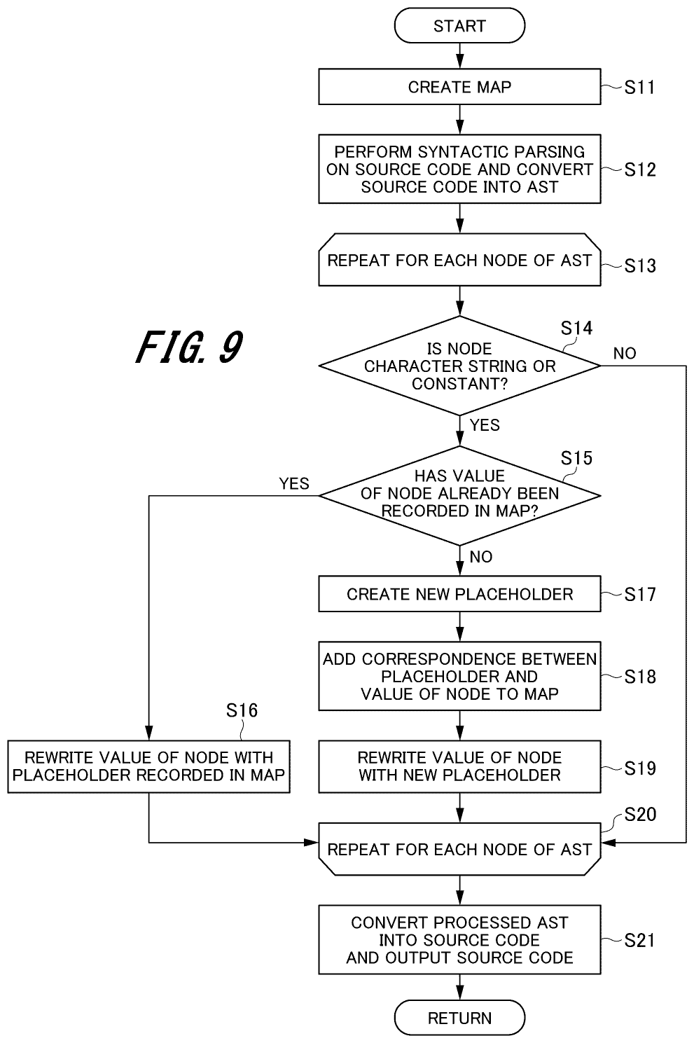

FIG. 9 is a flowchart showing an example of detailed processing of the data masking processing illustrated in Step S2 of FIG. 8. In description below, information showing correspondence between an original character string and a placeholder included in the placeholder mapping group 370 is referred to as a map.

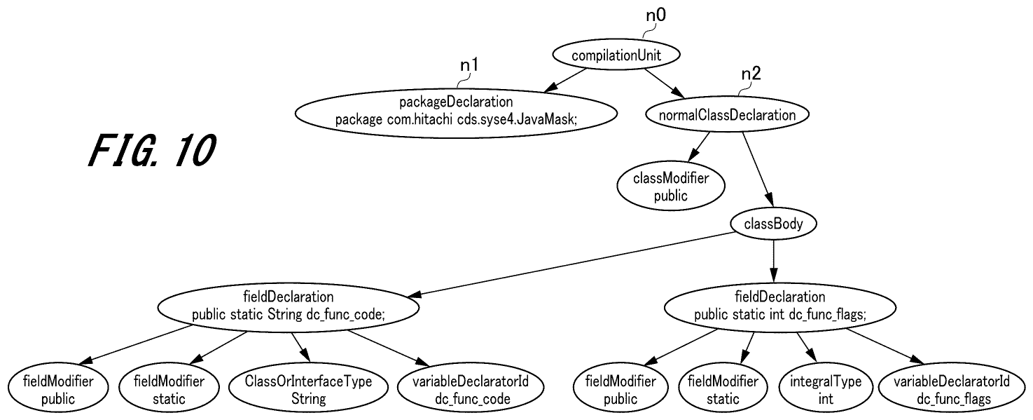

First, the data masking unit 220 creates a map (S11). Next, the data masking unit 220 performs syntactic parsing on source code of the source file 311 read from the learning candidate group 320 of FIG. 2 and converts the source code into an AST (S12). The conversion processing into an AST is performed by, for example, a parser included in the data masking unit 220. Here, an AST will be described with reference to FIG. 10.

FIG. 10 is a diagram illustrating an example of an AST.

An AST represents a grammatical structure of source code in a tree structure. In an AST, a token (character string, constant, and the like) of source code on which syntactic parsing is performed is converted as a node nx (x is an integer of zero or more). A node n0 is assigned to a route of an AST. Further, a leaf to which a node number is assigned, such as nodes n1, n2, . . . , is generated for the node n0. By converting source code into an AST in the above manner, a program of the language conversion processing according to the present embodiment becomes easy to handle.

Returning to FIG. 9, the description will be continued. After Step S12, the data masking unit 220 repeats processing below for each node of an AST (S13). First, the data masking unit 220 determines whether or not a node is a character string or a constant (S14). As for a node determined in Step S14, any character included in a character string is a determination target. For example, a period attached to a character string is also a determination target.

In a case where the node is neither a character string nor a constant (NO in S14), the data masking unit 220 moves to Step S20, increment a node number by “1”, and performs the determination in Step S14 again.

On the other hand, in a case where the node is either a character string or a constant (YES in S14), the data masking unit 220 determines whether a value of the node has already been recorded in a map (S15). For example, it is determined whether or not “MAINLOOP” as the original character string illustrated in FIG. 5 is recorded in a map.

If the value of the node has already been recorded in a map (YES in S15), the data masking unit 220 rewrites the value of the node with a placeholder recorded in the map (S16).

On the other hand, if the value of the node is not recorded in the map (NO in S15), the data masking unit 220 creates a new placeholder in the map (S17). Next, the data masking unit 220 adds correspondence between a placeholder and a value of the node to the map (S18). For example, if “MAINLOOP” as the original character string illustrated in FIG. 5 is not recorded in the map, “$var1” is created as a new placeholder, and correspondence between “MAINLOOP” and “$var1” is added to the map.

Next, the data masking unit 220 rewrites a value of a node of the AST with a new placeholder recorded in the map (S19). After the NO determination in Step S14, S16, or S19, the processing proceeds to Step S20, and the data masking unit 220 increments a node number by “1” and performs the determination of Step S14 again.

After repetitive processing on all nodes of the AST is completed, the data masking unit 220 converts the processed AST including the node rewritten with a placeholder into source code and outputs the source code (S21). After that, the processing returns to Step S3 in FIG. 8.

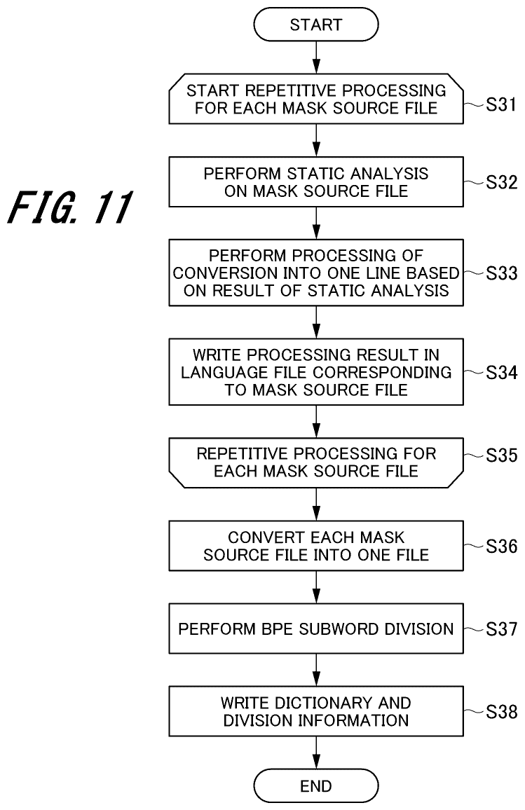

FIG. 11 is a flowchart illustrating an example of the preliminary learning data processing illustrated in Step S3 of FIG. 8.

The preliminary learning data processing unit 230 starts repetitive processing for each of the mask source files 331 and 332 read from the mask source file group 330 (S31). Next, the preliminary learning data processing unit 230 performs static analysis on the read mask source file (S32). Here, it is assumed that static analysis is first performed on the mask source file 331.

Next, based on a result of the static analysis, the preliminary learning data processing unit 230 performs processing so that source code of the mask source file 331 is in one line (S33). Next, the preliminary learning data processing unit 230 writes a processing result in the preliminary learning data file 341, which is a language file corresponding to the mask source file (S34).

Next, the preliminary learning data processing unit 230 determines whether there is an unprocessed mask source file (S35). If there is an unprocessed mask source file, the processing returns to Step S32 to perform static analysis. Here, static analysis is performed on the mask source file 332.

When it is determined in Step S35 that there is no unprocessed mask source file, the repetitive processing on the mask source files 331 and 332 ends. Next, the preliminary learning data processing unit 230 converts each of the mask source files 331 and 332 into one file (S36).

Next, the preliminary learning data processing unit 230 performs byte pair encoding (BPE) subword division (S37). The BPE is processing of further dividing a word with low frequency in a document by a statistical method. A word obtained by further dividing a word with low frequency is referred to as a subword. Through BPE subword division, division information is generated. For example, a character string “@@” written in the preliminary learning data files 341 and 342 illustrated in FIG. 6 indicates that a character string is divided by BPE subword division, and a divided character string including “@@” is referred to as divided information. For example, a character string 341c in FIG. 6, “dc-@@ func-@@ code”, indicates that “DC-FUNC-CODE” of a character string 331c illustrated in FIG. 4 is divided.

Finally, the preliminary learning data processing unit 230 writes a dictionary in the preliminary learning data group 340 and writes the division information in the translation model group 360 (S38). After that, the processing returns to Step S4 in FIG. 8.

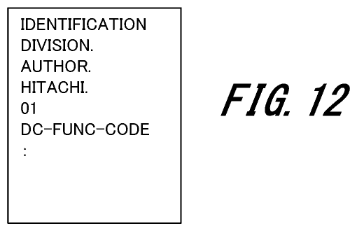

FIG. 12 is a diagram illustrating an example of a dictionary.

As described above, the dictionary is a set of all tokens written in preprocessed source code. FIG. 12 illustrates an example of a dictionary created based on the source file 311 illustrated in FIG. 3. By the preprocessing, a dictionary is created in a state in which an unnecessary token is removed. Then, this dictionary is written in the preliminary learning data group 340.

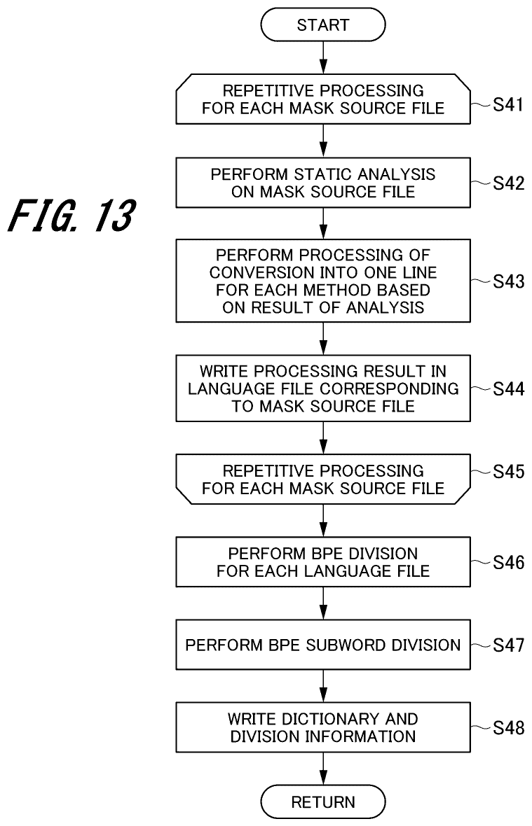

FIG. 13 is a flowchart illustrating an example of the main learning data processing illustrated in Step S5 of FIG. 8.

The main learning data processing unit 240 starts repetitive processing for each of the mask source files 331 and 332 read from the mask source file group 330 (S41). Next, the main learning data processing unit 240 performs static analysis on the read mask source file (S42). Here, it is assumed that static analysis is first performed on the mask source file 331.

Next, based on a result of the static analysis, the main learning data processing unit 240 performs processing so as to form one line for each method of the mask source file 331 (S43). Next, the main learning data processing unit 240 writes a processing result in the main learning data file 351 which is a language file corresponding to the mask source file (S44).

Next, the main learning data processing unit 240 determines whether there is an unprocessed mask source file (S45). If there is an unprocessed mask source file, the processing returns to Step S42 to perform static analysis. Here, static analysis is performed on the mask source file 332.

When it is determined in Step S45 that there is no unprocessed mask source file, the repetitive processing on the mask source files 331 and 332 ends. Next, the main learning data processing unit 240 converts each of the mask source files 331 and 332 into one file (S46).

Next, the main learning data processing unit 240 performs BPE subword division (S47). Through BPE subword division, division information is generated.

Finally, the main learning data processing unit 240 writes a dictionary and the division information into the main learning data group 350 (S48). After that, the processing returns to Step S6 in FIG. 8.

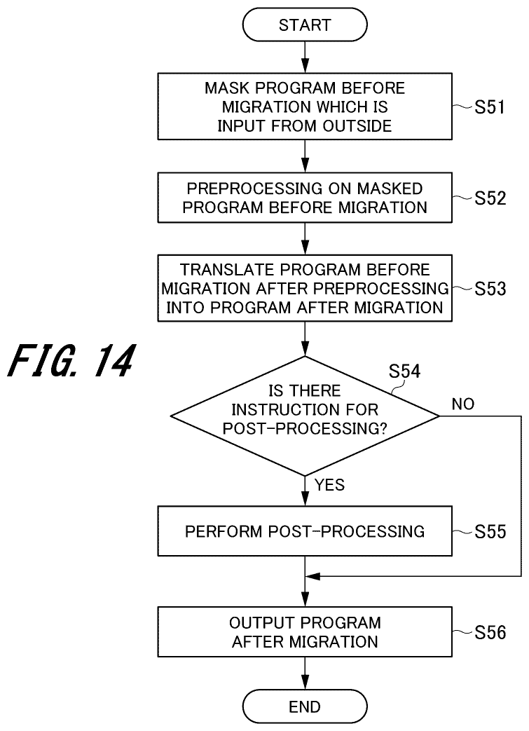

FIG. 14 is a flowchart illustrating an example of processing in a translation process of the programming language conversion device 100.

First, the data masking unit 220 masks a program before migration which is data input from the outside (S51).

Next, the translation unit 270 performs preprocessing on the masked program before migration (S52). This preprocessing is main learning data processing by the main learning data processing unit 240 illustrated in FIG. 2. In this preprocessing, division information is used.

Next, the translation unit 270 reads a translation model from the translation model group 360 and translates the program before migration after the preprocessing into a program after migration (S53). Next, the translation unit 270 determines whether or not there is an instruction for post-processing from the user (S54).

Output of a deep learning model is not certain. Further, if a placeholder attached to output source code is associated with a map, there is no guarantee that source code written in an accurate programming language after migration can be obtained. For this reason, there is a case where visual checking of a placeholder by the user and operation of returning a placeholder to an original character string are necessary.

If there is instruction for no post-processing (NO in S54), the translation unit 270 outputs a translated program after migration (S56). The program after migration output without being post-processed is in a state of being masked with a placeholder. For example, the mask source file 332 illustrated in FIG. 4 is displayed on the output device 150. Note that a map read from the placeholder mapping group 370 may also be displayed on the output device 150.

There is a possibility that a masked character string is written in Japanese, and in a case where this character string is changed to English or corrected, a program after migration is preferably in a state of being masked with a placeholder. Therefore, the user manually operates the input device 140 to restore a placeholders to an original character string by checking placeholders one by one.

A map stored in the placeholder mapping group 370 may have different correspondence between a placeholder and a character string for each project using source code. In this case, by converting a placeholder into a character string according to a project, source code having different description is created for each project if content of processing is the same.

If there is an instruction for post-processing (YES in S54), the post-processing unit 280 performs post-processing (S55). The post-processing replaces a placeholder in a program after migration with an original character string. Then, the translation unit 270 outputs a translated program after migration (S56). A program after migration that is post-processed and output is in a state in which a placeholder is replaced with an original character string. For example, the source file 312 illustrated in FIG. 3 is displayed on the output device 150. The user checks whether a placeholder of the source file 312 that is displayed is correctly restored to an original character string.

In the programming language conversion device 100 according to the first embodiment described above, since the data filtering unit 210 classifies source code for each topic and filters out a source file of a different topic, quality of a translation model can be improved.

Further, the data masking unit 220 creates a mask source file in which a constant and a character string written in each piece of source code are replaced with a placeholder by using a parser, and stores correspondence between the constant and the character string and the placeholder in the placeholder mapping group 370. For this reason, a character string and a constant do not overload a dictionary as in a conventional technique, and noise in preliminary learning and main learning can be reduced. As a result, it is possible to improve learning efficiency and maintain certain quality with a small data set of a legacy language.

Further, the preliminary learning unit 250 creates a translation model on which preliminary learning is performed based on a preliminary learning source file. Furthermore, the main learning unit 260 performs main learning using a translation model based on a main learning source file. The translation unit 270 can obtain a high-quality translation result by using the translation model created in this manner. Further, by providing a translation model to another one of the programming language conversion device 100 or incorporating a translation model into a translation program (not illustrated), translation quality of a device other than the programming language conversion device 100 that creates the translation model can also be improved.

Further, the translation unit 270 can apply an externally input source file written in a programming language before migration to a translation model to translate the source file to a source file written in a programming language after migration. For this reason, time required for translation can be shortened s compared with a conventional method.

Further, highly accurate translation can be performed using a translation model updated by main learning.

### Second Embodiment

Next, a programming language conversion system according to a second embodiment of the present invention will be described.

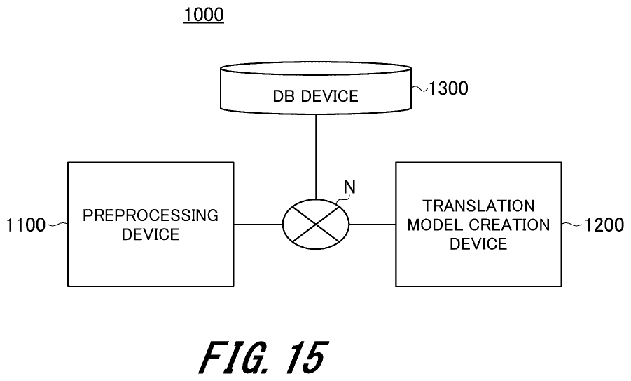

FIG. 15 is a block diagram illustrating a configuration example of a programming language conversion system 1000.

The programming language conversion system 1000 includes a preprocessing device 1100, a translation model creation device 1200, and a DB device 1300 that are connected to each other via a network N and can transmit and receive various pieces of data.

The preprocessing device 1100 includes the data filtering unit 210 and the data masking unit 220 illustrated in FIG. 2. Before learning processing according to the present embodiment, a service provider performs data filtering processing and data masking processing.

The translation model creation device 1200 includes the preliminary learning data processing unit 230, the main learning data processing unit 240, the preliminary learning unit 250, the main learning unit 260, the translation unit 270, and the post-processing unit 280 illustrated in FIG. 2.

The DB device 1300 includes the source file group 310, the learning candidate group 320, the mask source file group 330, the preliminary learning data group 340, the main learning data group 350, the translation model group 360, and the placeholder mapping group 370 included by the information storage unit 300 illustrated in FIG. 2. The DB device 1300 may be a device managed by a service provider.

As the programming language conversion system 1000 is constituted in this manner, data filtering processing and data masking processing can be performed in advance. For this reason, the translation model creation device 1200 can create a translation model by performing preliminary learning and main learning based on a mask source file subjected to data masking processing.

### Variation

The programming language conversion device 100 according to the above-described embodiment is an example in which the present invention is applied to unsupervised learning, but the present invention may also be applied to supervised learning. Note that, in supervised learning, the data filtering unit 210 may be removed from the programming language conversion device 100.

Further, a programming language before migration may be the C language, and a programming language after migration may be Python. In addition, a combination in which a programming language before migration is Job Control Language (JCL) and a programming language after migration is the Java language is also assumed. As described above, a combination of a programming language before migration and a programming language after migration may be optional.

Further, if program languages are the same, a format of a command may be different due to different versions. For example, Version 2.X and Version 3.X of Python have different formats and are incompatible. In this case, a program before migration may be created in Python Version 2.X (first program language), and a program after migration may be created in Python Version 3.X (second program language).

Note that the present invention is not limited to the above-described embodiment, and, as a matter of course, various other application examples and variations can be taken without departing from the gist of the present invention described in the claims.

For example, the above embodiment specifically describes a configuration of a system in detail for easy understanding of the present invention, and the present invention is not necessarily limited to an embodiment that includes all the described configurations. Further, for a part of a configuration of the present embodiment, another configuration may also be added, removed, or replaced with.

Further, a control line and an information line that are considered necessary for explanation are shown, and not all control lines or information lines on a product are necessarily shown. In practice, almost all configurations may be considered to be connected mutually.

### Reference Signs List

100 programming language conversion device
110 processor
120 main storage device
210 data filtering unit
220 data masking unit
230 preliminary learning data processing unit
240 main learning data processing unit
250 preliminary learning unit
260 main learning unit
270 translation unit
280 post-processing unit
300 information storage unit
310 source file group
320 learning candidate group
330 mask source file group
340 preliminary learning data group
350 main learning data group
360 translation model group
370 placeholder mapping group

1. A programming language conversion device comprising:
a masking unit that masks a specific type of token of first source code written in a first programming language with a different placeholder for each of the tokens; and
a learning unit that learns the first source code masked with the placeholder and creates a translation model for converting the first source code into second source code written in a second programming language.

2. The programming language conversion device according to claim 1, further comprising
a filtering unit that filters the first source code based on a topic,
wherein the masking unit masks the filtered first source code with a different placeholder for each of the tokens.

3. The programming language conversion device according to claim 2, further comprising
a translation unit that applies the translation model to the first source code and converts the first source code into the second source code.

4. The programming language conversion device according to claim 3, wherein the translation unit outputs the second source code masked with the placeholder in a case where there is no instruction for post-processing.

5. The programming language conversion device according to claim 3, further comprising
a post-processing unit that performs post-processing of returning the placeholder to an original state and outputs the second source code for which post-processing is performed in a case where there is an instruction for post-processing.

6. The programming language conversion device according to claim 5, further comprising
a preliminary learning data processing unit that performs processing of converting the first source code masked with the placeholder into preliminary learning data,
wherein the learning unit includes a preliminary learning unit that creates the translation model in which features of the first programming language and the second programming language are learned based on the preliminary learning data.

7. The programming language conversion device according to claim 6, further comprising
a main learning data processing unit that performs processing of converting the first source code masked with the placeholder into main learning data,
wherein the learning unit includes a main learning unit that creates the translation model based on the main learning data.

8. A programming language conversion method comprising:
masking a specific type of token of first source code written in a first programming language with a different placeholder for each of the tokens; and
learning the first source code masked with the placeholder and creating a translation model for converting the first source code into second source code written in a second programming language.

9. A programming language conversion system comprising:
a preprocessing device; and
a translation model creation device,
wherein the preprocessing device includes a masking unit that masks a specific type of token of first source code written in a first programming language with a different placeholder for each of the tokens, and
the translation model creation device includes a learning unit that learns source code masked with the placeholder and creates a translation model for converting the first source code into second source code written in a second programming language.
